(19) United States
(12) Patent Application Publication
(10) Pub. No.: US 2004/0191424 A1
(43) Pub. Date: Sep. 30, 2004

(54) Read/write disc scratch prevention process

(76) Inventor: Tsang-Feng Ho, Lu-Chu Hsiang (TW)

Correspondence Address: TROXELL LAW OFFICE PLLC, 5205 LEESBURG PIKE, SUITE 1404, FALLS CHURCH, VA, 22041, US

(21) Appl. No.: 10/396,778

(22) Filed: Mar. 26, 2003

(51) Int. Cl. B05D 3/06

(52) U.S. Cl. 427/558

(57) ABSTRACT

A read/write disc scratch prevention process involves having an injection comprised of resin, monomer, photosensitizer and catalyst mixed at a proper ratio evenly coated by means of an eccentric method on the data read/write surface of a disc, then the coated surface UV cured to transform compositions in the injection into a transparent film of given hardness, thus to form an effective scratch prevention for the data read/write surface of the disc and to provide longer service life of the disc by maintaining a neat and leveled data rear/write surface, and permitting to be done before burning the data into the disc for assurance of data writing accuracy and preventing scratch.

### BACKGROUND OF THE INVENTION

(a) Field of the Invention

The present invention is related to a process of scratch prevention read/write disc, and more particularly, to one that provides a UV cured transparent film on the surface of the disk to maintain a neat and leveled read/write surface, thus to prevent scratch, and improve service life of the disc.

(b) Description of the Prior Art

Whereas in reading data from a disc of the prior art, the read/write head projects a laser beam and reads the status of the laser beam reflected by the pits on the aluminum area in the disk, routes traveled of the projection and reception by the laser beam directly affect the accuracy of reading data from that particular location on the disk. Therefore, the data read/write layer in the disc must be kept strictly leveled to avoid any scratch that may affect the travel of the laser beam and compromise the accuracy of read out and write in of the data in general.

However, the scratch prevention process is usually done after the completion of the data input to the disc. To avoid affecting the properties of the data layer of the disc, another layer of scratch prevention is laminated to the existing disk, resulting in complicate process, higher production cost, and less competitive in the market. Since the scratch prevention layer of the prior art is laminated after the completion of the data input, it fails to prevent any scratch already exists before the lamination; and that will cause higher chance of error in writing the data.

### SUMMARY OF THE INVENTION

The primary purpose of the present invention is to provide a process of a scratch prevention read/write disc. To achieve the purpose, an injection comprised resin, monomer, photosensitizer, and catalyst mixed at proper ratio is evenly coated on the data read/write surface layer of the disk, then the coated injection is UV cured for the compositions in the injection to be transformed in to a transparent film with a given hardness. The transparent film will not affect the read/write head in reading data, and will provide an effective scratch prevention effect for the data read/write surface of the disc by keeping it neat and leveled to improve the service life of the disc.

Another purpose of the present invention is to provide a process of a scratch prevention read/write disc that the transparent film is applicable for post-production upon the data have been burnt into the disc. To achieve the purpose, the scratch prevention surface comprised of the transparent film hardened and transformed from the polymerization of the UV cured injection will not damage the properties of the existing data layer of the disc.

Another purpose yet of the present invention is to provide a process of a scratch prevention read/write disc that allows the process of the transparent film for scratch prevention to be done before burning the data into the disc, since the transparent film will not affect the data read by the write/read head from the disc so to assure of the accuracy of data written in the disk, and to prevent the creation of any scratch while writing data into the disc for quality assurance of the disc production.

Another purpose yet of the present invention is to provide a process of a scratch prevention read/write disc that allows the addition of pigment in any color desired into the injection to be coated on the disc, then UV cured to form the transparent film in its distinct color to be told from other discs.

### BRIEF DESCRIPTION OF THE DRAWINGS

FIG. 1 is a perspective view of a disk of the present invention.

FIG. 2 is sectional view of the disc showing the layers of the scratch prevention surface and the body of the disc.

### DETAILED DESCRIPTION OF THE PREFERRED EMBODIMENTS

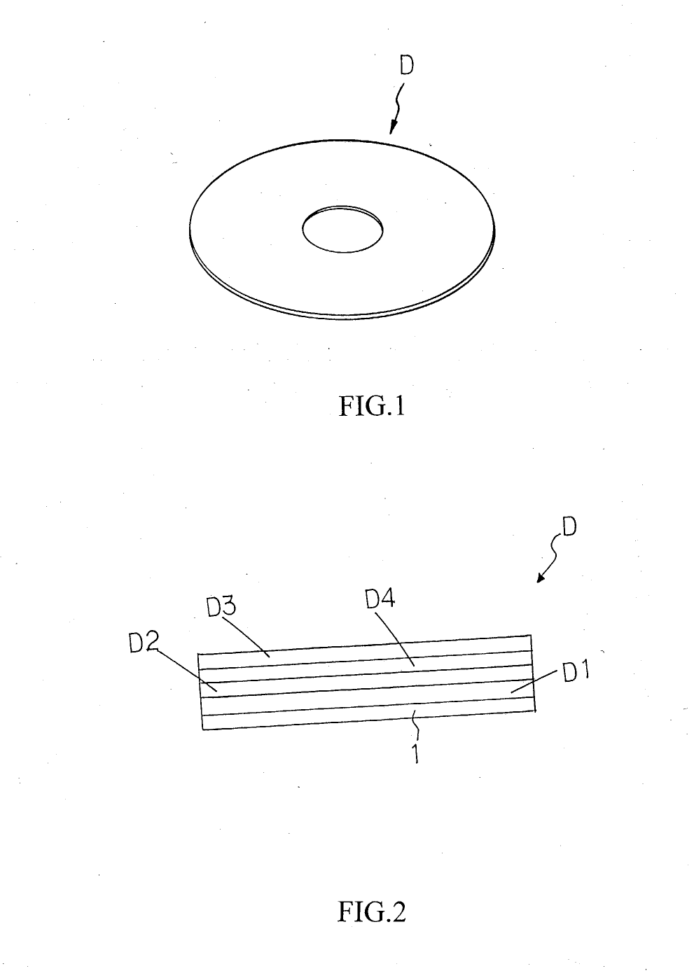

Referring to FIG. 1 for the layout of a scratch prevention surface and a body of a disc of the present invention, the disc (D) is essentially comprised of a PC layer (D1), topped by a data layer (D2), a reflection layer (D3) and a protection layer (D4) in sequence. The opposite side of the PC layer (D1) provided with the a data layer (D2), the reflection layer (D3) and the protection layer (D4) is where to permit a rear/write head to project laser beam upon it for reading/writing data. A scratch prevention layer (1) is provided below the PC layer (D1) to form an effective scratch prevention layer for the data write/read surface of the disc (D) by maintaining a neat and leveled date read/write surface for improving the service life of the disc.

In the process of the scratch prevention surface, an injection containing resin, monomer, photosensitizer, and catalyst mixed at proper ratio is evenly coated by eccentric method on the data read/write surface of the disc and then the disc is UV cured. Wherein, the resin may be of (methyl) acrylate, epoxy (methyl) acrylate, or carbamic ester (methyl) acrylate; the monomer may be of TMPA (Trimethylopropane Triacrylate) and its EO. PO modified monomer, TPGDA (Trimethylopropane Glycol Diacrylate) and its EO. PO modified monomer, HDDA (1.6 Hexanediol) Diacrylate) and its EO. PO modified monomer, NVP (N-vinyl-pyrolindone) and its EO. PO modified monomer, DPPA (Dipentaerythritol pentaacrylate) and its EO. PO modified monomer, PETTA (Pentaerythritol Tetraacrylate) and its EO. PO modified monomer, or DPHA (Dipentaerythritol Hexa-accrylate) and its EO. PO modified monomer; the photosensitizer may be of Irgacure-184, Irgacure-907, Irgacure-819, Irgacure-369, Darocur-1173, Bp(Benzophenone).

Depending on the application, the injection may be comprised of 10˜60% resin, 10˜40% monomer, 5˜20% photosensitizer, and 0.5˜5% catalyst in a viscosity of 30˜100 cps/25° C. to be evenly coated by an eccentric method on the data read/write surface of the disc at a working temperature of 35-60° C. 1˜5 second of UV-curing is followed after the coating for the compositions in the injection to transform into a transparent film in a hardness between 2 H˜7 H. The transparent film provides effective scratch prevention for the data read/write surface of the disc and longer service life for the disk by maintaining a neat and leveled data read/write surface. Furthermore, pigment in a color desired may be added into the injection to display the color after UV curing so to distinguish the disc of the present invention from other discs.

Whereas, the scratch prevention surface of the present invention is comprised of the transparent film with a given hardness due to the UV curing process to transform the polymerization of the injection without causing damage to the properties of the data layer of the disc, the process can be done after the burning of data in the disc. On the other hand, since the transparent film will not affect data reading by the read/write head, the process of the present invention can be done before data burning to assure of the accuracy of data written in and prevent scratch in the process of data writing. Therefore, the process of the present invention allows the choice of having it done before or after data burning depending on the disc manufacturing setup. In either way, the process of the present invention will not affect the process setup for the disc.

The process of the present invention by having an injection comprised of resin, monomer, photosensitizer and catalyst mixed at a proper ratio evenly coated by means of an eccentric method on the data read/write surface of a disc, then the coated surface UV cured to transform compositions in the injection into a transparent film of given hardness, thus to form an effective scratch prevention for the data read/write surface of the disc and to provide longer service life of the disc by maintaining a neat and leveled data rear/write surface, and permitting to be done before burning the data into the disc for assurance of data writing accuracy and preventing scratch to the disc in data writing since the transparent film will not affect the data reading by the read/write head, offers a better and feasible scratch prevention process for the disc; therefore, this application is duly filed accordingly.

I claim,

1. A read/write disc scratch prevention process is essentially comprised of having an injection comprised of resin, monomer, photosensitizer and catalyst mixed at a proper ratio evenly coated by means of an eccentric method on the data read/write surface of a disc, then the coated surface UV cured to transform compositions in the injection into a transparent film of given hardness, thus to form an effective scratch prevention for the data read/write surface of the disc and to provide longer service life of the disc by maintaining a neat and leveled data rear/write surface, and permitting to be done before burning the data into the disc for assurance of data writing accuracy and preventing scratch.

2. A read/write disc scratch prevention process as claimed in claim 1, wherein, the injection is evenly coated by means of an eccentric method on the data read/write surface of the disc under the working temperature of 35˜60° C. on the surface of the disc.

3. A read/write disc scratch prevention process as claimed in claim 1, wherein, depending on the application, the injection may be comprised of 10˜60% resin, 10˜40% monomer, 5˜20% photosensitizer, and 0.5˜5% catalyst in a viscosity of 30˜100 cps/25° C. to be evenly coated and followed with 1˜5 second of UV-curing.

4. A read/write disc scratch prevention process as claimed in claim 1, wherein, a pigment in a color desired may be added into the injection to display the color after UV curing so to distinguish the disc of the present invention from other discs.

5. A read/write disc scratch prevention process as claimed in claim 1, wherein, the resin may be of (methyl) acrylate, epoxy (methyl) acrylate, or carbamic ester (methyl) acrylate.

6. A read/write disc scratch prevention process as claimed in claim 1, wherein, the monomer may be of TMPA (Trimethylopropane Triacrylate) and its EO. PO modified monomer, TPGDA (Trimethylopropane Glycol Diacrylate) and its EO. PO modified monomer, HDDA (1.6 Hexanediol) Diacrylate) and its EO. PO modified monomer, NVP (N-vinyl-pyrolindone) and its EO. PO modified monomer, DPPA (Dipentaerythritol pentaacrylate) and its EO. PO modified monomer, PETTA (Pentaerythritol Tetraacrylate) and its EO. PO modified monomer, or DPHA (Dipentaerythritol Hexa-accrylate) and its EO. PO modified monomer.

7. A read/write disc scratch prevention process as claimed in claim 1, wherein, the photosensitizer may be of Irgacure-184, Irgacure-907, Irgacure-819, Irgacure-369, Darocur-1173, or Bp (Benzophenone).
